(19) United States
(12) Patent Application Publication
(10) Pub. No.: US 2012/0132847 A1
(43) Pub. Date: May 31, 2012

(54) MAGNETIC MATERIAL COMPOSITION FOR CERAMIC ELECTRONIC COMPONENT, METHOD OF MANUFACTURING THE SAME, AND CERAMIC ELECTRONIC COMPONENT USING THE SAME

(75) Inventors: SUNG YONG AN, Anyang (KR); Jeoung Wook Kim, Busan (KR); Sung Lyoung Kim, Bucheon (KR); Soo Hwan Son, Seoul (KR); Jin Woo Hahn, Yongin (KR); Ic Seob Kim, Yongin (KR)

(73) Assignee: SAMSUNG ELECTRO-MECHANICS CO., LTD.

(21) Appl. No.: 13/031,921

(22) Filed: Feb. 22, 2011

(30) Foreign Application Priority Data
Nov. 26, 2010 (KR) 10-2010-0118685

(51) Int. Cl. H01F 1/01

(52) U.S. Cl. 252/62.59

(57) ABSTRACT

A magnetic material composition for ceramic electronic components that is excellent in sintering properties and magnetic properties (in particular, a Q-factor) and a manufacturing method thereof, and a ceramic electronic component using the magnetic material composition are provided. The magnetic material composition includes Ni—Zn—Cu ferrite powder formed of 47.0 to 49.5 parts by mole of a mixture of iron oxide (Fe₂O₃), cobalt oxide (CoO), and titanium oxide (TiO₂), 16.0 to 24.0 parts by mole of nickel oxide (NiO), 18.0 to 25.0 parts by mole of zinc oxide (ZnO), and 7.0 to 13.0 parts by mole of copper oxide (CuO). A ceramic electronic component manufactured using the magnetic material composition has an excellent Q-factor.

### CROSS-REFERENCE TO RELATED APPLICATIONS

This application claims the priority of Korean Patent Application No. 2010-0118685 filed on Nov. 26, 2010, in the Korean Intellectual Property Office, the disclosure of which is incorporated herein by reference.

### BACKGROUND OF THE INVENTION

1. Field of the Invention

The present invention relates to a magnetic material composition for ceramic electronic components, a method of manufacturing the same, and a ceramic electronic component using the magnetic material composition. More particularly, the present invention relates to a magnetic material composition for ceramic electronic components that is excellent in sintering properties and magnetic properties, a method of manufacturing the same, and a ceramic electronic component using the magnetic material composition.

2. Description of the Related Art

As various electronic communication devices, such as mobile phones and the like are developed, multilayered ceramic electronic components are increasingly in demand to implement various functions of electronic circuit boards. Since a multilayered ceramic electronic component manufactured using magnetic ceramic materials utilizes a low-melting point material, such as silver (Ag) and cooper (Cu), for an internal printed circuit, magnetic ceramic materials sinterable at low-temperature are required.

Generally, magnetic materials for low-temperature sintered ceramic magnetic components, such as a multilayered chip inductor, a multilayered chip bead, a power inductor, and the like, may include, for example, Ni—Zn ferrites, Ni—Zn—Cu ferrites, and the like. To improve the sintering properties of Ni—Zn ferrites, Cu is added to the Ni—Zn ferrites to thereby obtain a Ni—Zn—Cu ferrite ternary system composition. Iron (Fe) may be substituted with a trivalent ion such as aluminum (Al), chromium (Cr) and the like, or with a tetravalent ion such as tin (Sn), titanium (Ti) and the like. Additionally, Ni, Zn and Cu may be substituted with a divalent ion such as manganese (Mn), cobalt (Co), magnesium (Mg), and the like.

To improve the magnetic properties of Ni—Zn—Cu ferrites, nickel oxide (NiO), zinc oxide (ZnO), copper oxide (CuO), and iron oxide (Fe₂O₃) are used as main ingredients, and lithium oxide (Li₂O), tin oxide (SnO₂), cobalt oxide (Co₃O₄), bismuth oxide (Bi₂O₃), manganese oxide (Mn₃O₄) and the like are added as secondary ingredients at a ratio of 5 wt % with respect to the main ingredients, such that initial permeability, sintering density, saturation magnetization, and the like may be adjusted. However, when a material added as a secondary ingredient is not fully soluble in an A-site or B-site in a ferrite lattice, a secondary phase such as α-Fe₂O₃ (hematite), CuO, Cu₂O and the like may be formed, which may cause the deterioration of the magnetic properties of Ni—Zn—Cu ferrites.

### SUMMARY OF THE INVENTION

An aspect of the present invention provides a magnetic material composition for ceramic electronic components that is excellent in sintering properties and magnetic properties, and a manufacturing method thereof, and a ceramic electronic component using the magnetic material composition.

According to an aspect of the present invention, there is provided a magnetic material composition for ceramic electronic components, including Ni—Zn—Cu ferrite powder formed of 47.0 to 49.5 parts by mole of a mixture of iron oxide (Fe₂O₃), cobalt oxide (CoO), and titanium oxide (TiO₂), 16.0 to 24.0 parts by mole of nickel oxide (NiO), 18.0 to 25.0 parts by mole of zinc oxide (ZnO), and 7.0 to 13.0 parts by mole of copper oxide (CuO).

A content of CoO may be equal to a content of TiO₂.

A content of each of CoO and TiO₂ may be in the range of 0.05 to 1.0 part by mole.

The magnetic material composition may further include silver nitrate (AgNO₃).

A content of AgNO₃ may be in the range of 0.01 to 0.5 parts by weight with respect to 100 parts by weight of the Ni—Zn—Cu ferrite powder.

According to another aspect of the present invention, there is a method of manufacturing a magnetic material composition for ceramic electronic components, including: preparing raw materials including Fe₂O₃, NiO, ZnO, CuO, CoO, and TiO₂; mixing the raw materials and performing liquid milling on a mixture of the raw materials; and manufacturing Ni—Zn—Cu ferrite powder by drying the milled mixture and calcining the dried mixture.

The method may further include, after the manufacturing, mixing AgNO₃ in the manufactured Ni—Zn—Cu ferrite powder.

A content of AgNO₃ may be in the range of 0.01 to 0.5 parts by weight with respect to 100 parts by weight of the Ni—Zn—Cu ferrite powder.

The Ni—Zn—Cu ferrite powder may be formed with 47.0 to 49.5 parts by mole of a mixture of Fe₂O₃, CoO, and TiO₂, 16.0 to 24.0 parts by mole of NiO, 18.0 to 25.0 parts by mole of ZnO, and 7.0 to 13.0 parts by mole of CuO.

A content of each of CoO and TiO₂ may be in the range of 0.05 to 1.0 part by mole.

The calcining of the mixture may be performed at 700° C. to 800° C.

According to another aspect of the present invention, there is a ceramic electronic component, including: a magnetic material sheet manufactured using a magnetic material composition including Ni—Zn—Cu ferrite powder formed of 47.0 to 49.5 parts by mole of a mixture of Fe₂O₃, CoO, and TiO₂, 16.0 to 24.0 parts by mole of NiO, 18.0 to 25.0 parts by mole of ZnO, and 7.0 to 13.0 parts by mole of CuO; and an internal electrode formed on the magnetic material sheet.

A content of each of CoO and TiO₂ may be in the range of 0.05 to 1.0 part by mole.

A magnetic material composition further comprises silver nitrate (AgNO₃).

A content of AgNO₃ may be in the range of 0.01 to 0.5 parts by weight with respect to 100 parts by weight of the Ni—Zn—Cu ferrite powder.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart of a method of manufacturing a magnetic material composition for ceramic electronic components according to an exemplary embodiment of the present invention;

FIG. 2A is a perspective view schematically illustrating the external appearance of a ceramic electronic component according to an exemplary embodiment of the present invention;

FIG. 2B is a vertical cross-sectional view of the ceramic electronic component of FIG. 2A;

FIG. 3 is a diagram illustrating a change in density based on a sintering temperature of a magnetic material according to an exemplary embodiment of the present invention;

FIG. 4 is a diagram illustrating a change in shrinkage based on a sintering temperature of a magnetic material according to an exemplary embodiment of the present invention;

FIG. 5 is a diagram illustrating a change in initial permeability based on a sintering temperature of a magnetic material according to an exemplary embodiment of the present invention;

FIG. 6 is a diagram illustrating a change in Q-factor based on a sintering temperature of a magnetic material according to an exemplary embodiment of the present invention;

FIG. 7 is a diagram illustrating a change in saturation magnetization (Ms) based on a sintering temperature of a magnetic material according to an exemplary embodiment of the present invention;

FIG. 8 is a diagram illustrating a change in coercive force (Hc) based on a sintering temperature of a magnetic material according to an exemplary embodiment of the present invention;

FIG. 9 is a diagram illustrating a change in density based on a sintering temperature of a magnetic material according to comparative examples;

FIG. 10 is a diagram illustrating a change in shrinkage based on a sintering temperature of a magnetic material according to comparative examples;

FIG. 11 is a diagram illustrating a change in initial permeability based on a sintering temperature of a magnetic material according to comparative examples;

FIG. 12 is a diagram illustrating a change in Q-factor based on a sintering temperature of a magnetic material according to comparative examples;

FIG. 13 is a diagram illustrating a change in saturation magnetization (Ms) based on a sintering temperature of a magnetic material according to comparative examples; and

FIG. 14 is a diagram illustrating a change in coercive force (Hc) based on a sintering temperature of a magnetic material according to comparative examples.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

According to an exemplary embodiment of the present invention, a magnetic material composition for ceramic electronic components may include Ni—Zn—Cu ferrite powder which is formed of 47.0 to 49.5 parts by mole of a mixture of iron oxide (Fe₂O₃), cobalt oxide (CoO) and titanium oxide (TiO₂), 16.0 to 24.0 parts by mole of nickel oxide (NiO), 18.0 to 25.0 parts by mole of zinc oxide (ZnO), and 7.0 to 13.0 parts by mole of copper oxide (CuO).

Ferrite powder may be mainly used as a magnetic material in a low-temperature sintering ceramic magnetic component, such as a multilayered chip inductor, a multilayered chip bead, a power inductor, and the like. Here, a Ni—Zn—Cu ferrite composition may be formed by adding Cu to the ferrite powder, to improve sintering properties.

In the exemplary embodiment of the present invention, a Ni—Zn—Cu ferrite including 47.0 to 49.5 parts by mole of Fe₂O₃, 16.0 to 24.0 parts by mole of NiO, 18.0 to 25.0 parts by mole of ZnO, and 7.0 to 13.0 parts by mole of CuO may be used. Since sintering properties and electrical properties may vary depending on contents of NiO, ZnO, CuO, and Fe₂O₃ in the Ni—Zn—Cu ferrite, a composition range with excellent sintering properties may be optimized.

The magnetic material composition may include CoO and TiO₂ which are used to substitute a portion of Fe₂O₃.

Generally, an oxide including a trivalent atom having the same valency as Fe³⁺ in Fe₂O₃, for example Al³⁺ or Cr³⁺, is added. However, in the exemplary embodiment, CoO and TiO₂, corresponding to an average valency of +3 per atom obtained by combining a divalent atom and a tetravalent atom, may be manufactured as a substitute for a portion of Fe₂O₃.

At the same time, Fe₂O₃ may be reduced by the same amount as that of CoO and TiO₂ to be added. In other words, CoO and TiO₂ may be added in amounts corresponding to the reduced amount of Fe₂O₃.

When a material added as a secondary ingredient is not fully soluble in an A-site or B-site in a ferrite lattice, a secondary phase such as α-Fe₂O₃ (hematite), CuO, Cu₂O, and the like may be formed, which may deteriorate magnetic properties. Accordingly, to prevent the secondary phase from being formed, the amount of Fe₂O₃ may be reduced, and CoO and TiO₂ may be added in amounts corresponding to the reduced amount of Fe₂O₃.

The Ni—Zn—Cu ferrite powder in which a portion of Fe₂O₃ is substituted with CoO and TiO₂ may be sintered at a temperature lower than 951° C., the volatilization temperature of silver (Ag) used as an internal electrode of a low-temperature sintering ceramic magnetic component, such as a multilayered chip inductor. This is because activation energy required to move atoms on the surfaces of particles may be reduced by adding CoO and TiO₂, so that the atoms may be easily moved at a relatively low temperature and thus, sintering may be performed at a relatively low temperature.

The sintering may be performed at a temperature from 880° C. to 920° C., but there is no limitation thereto.

A content of each of CoO and TiO₂ may be in the range of 0.05 to 1.0 part by mole. The maximum content of a mixture of CoO and TiO₂ may be 2.0 parts by mole. The contents of CoO and TiO₂ may be limited to a very small amount of 2.0 parts by mole or less, in order to prevent a secondary phase from being formed.

The contents of CoO and TiO₂ may be equal to each other. In other words, CoO and TiO₂ may be contained in equal parts by mole, and may equally substitute Fe₂O₃.

The magnetic material composition may be used to manufacture a chip inductor, a chip bead, a ferrite core, and the like, and may also be used as materials of an inductor with a shape of a toroidal core.

A ceramic electronic component may be manufactured using the magnetic material composition for ceramic electronic components, which includes Ni—Zn—Cu ferrite powder formed of 47.0 to 49.5 parts by mole of a mixture of Fe₂O₃, CoO, and TiO₂, 16.0 to 24.0 parts by mole of NiO, 18.0 to 25.0 parts by mole of ZnO, and 7.0 to 13.0 parts by mole of CuO. The ceramic electronic component may be excellent in magnetic properties, in particular, in a Q factor (Q).

In the exemplary embodiment, the magnetic material composition may further include silver nitrate (AgNO₃). The AgNO₃ may act as a sintering accelerator to lower the activation energy of atoms on the surfaces of particles, so that the mobility of the atoms may be increased. Accordingly, it is possible to perform sintering at a low temperature.

A content of AgNO₃ may range from 0.01 to 0.5 parts by weight with respect to 100 parts by weight of the Ni—Zn—Cu ferrite powder. This is because when the content of AgNO₃ exceeds 0.5 parts by weight, a secondary phase may be formed, thereby impairing magnetic properties.

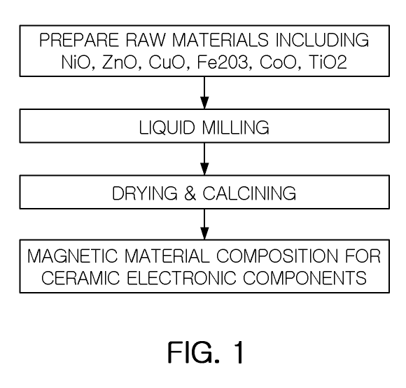

FIG. 1 is a flowchart of a method of manufacturing a magnetic material composition for ceramic electronic components according to an exemplary embodiment of the present invention.

Referring to FIG. 1, the method of manufacturing the magnetic material composition for ceramic electronic components may include preparing raw materials including Fe₂O₃, NiO, ZnO, CuO, CoO, and TiO₂, mixing the raw materials and performing liquid-milling on a mixture of the raw materials, and manufacturing Ni—Zn—Cu ferrite powder by drying the milled mixture and calcining the dried mixture.

More specifically, raw materials including Fe₂O₃, NiO, ZnO, CuO, CoO, and TiO₂ may be prepared. The Fe₂O₃, NiO, ZnO, CuO, CoO, and TiO₂ may be weighed so that 47.0 to 49.5 parts by mole of a mixture of Fe₂O₃, CoO, and TiO₂, 0.05 to 1.0 part by mole of CoO, 0.05 to 1.0 part by mole of TiO₂, 16.0 to 24.0 parts by mole of NiO, 18.0 to 25.0 parts by mole of ZnO, and 7.0 to 13.0 parts by mole of CuO may be present.

The weighed raw materials may be mixed, and liquid milling may be performed upon a mixture of the weighed raw materials. A mixture may be manufactured by mixing the weighed raw materials with distilled water containing ethanol. The distilled water and the ethanol may be mixed at a weight ratio of 100:5. Beads may be put in the mixture. The amount of bead being put therein may be five times greater than the weight of the mixture. Milling may be performed such that specific surface areas of the materials may be in the range of 3.0 to 5.0 m²/g.

A magnetic material powder for ceramic electronic components may be manufactured by drying the milled mixture and calcining the dried mixture. The mixture obtained after the liquid milling may be dried using a drying oven and the like, and the dried mixture may be calcined. The mixture may be calcined after the dried mixture is pulverized. As a pulverization method, generally well-known methods such as a milling method may be used.

The calcining may be performed at a temperature of 700° C. to 800° C. in which a single ferrite phase is formed rather than a secondary phase such as a hematite (α-Fe₂O₃) phase. This is because when a secondary phase such as a hematite (α-Fe₂O₃) is formed, magnetic properties may be impaired.

The manufactured magnetic material powder may have a composition ratio for 47.0 to 49.5 parts by mole of a mixture of Fe₂O₃, CoO, and TiO₂, 0.05 to 1.0 part by mole of CoO, 0.05 to 1.0 part by mole of TiO₂, 16.0 to 24.0 parts by mole of NiO, 18.0 to 25.0 parts by mole of ZnO, and 7.0 to 13.0 parts by mole of CuO.

The method of manufacturing the magnetic material composition may further include, mixing AgNO₃ in the manufactured Ni—Zn—Cu ferrite powder after the manufacturing of the Ni—Zn—Cu ferrite powder. When the AgNO₃ is mixed in the Ni—Zn—Cu ferrite powder, the sintering properties may be increased and a sintering temperature may be lowered.

The content of the AgNO₃ may be in the range of 0.01 to 0.5 parts by weight with respect to 100 parts by weight of the Ni—Zn—Cu ferrite powder. When the content of AgNO₃ exceeds 0.5 parts by weight, a secondary phase may be generated, thereby causing the deterioration of magnetic properties of a sintered material.

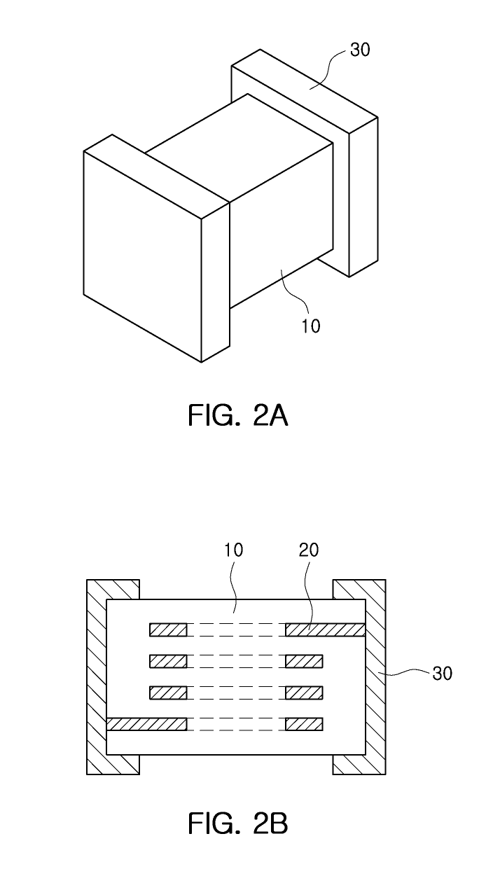

FIG. 2A is a perspective view schematically illustrating an external appearance of a ceramic electronic component according to an exemplary embodiment of the present invention, and FIG. 2B is a vertical cross-sectional view of a ceramic electronic component according to an exemplary embodiment of the present invention.

In the exemplary embodiment, a multilayered inductor will be described as an example of the ceramic electronic component.

The multilayered inductor may include magnetic material sheets, internal electrodes 20, a magnetic main body 10, and external electrodes 30. The magnetic material sheets may be manufactured using a magnetic material composition for ceramic electronic components which includes Ni—Zn—Cu ferrite powder formed with 47.0 to 49.5 parts by mole of a mixture of Fe₂O₃, CoO, and TiO₂, 16.0 to 24.0 parts by mole of NiO, 18.0 to 25.0 parts by mole of ZnO, and 7.0 to 13.0 parts by mole of CuO. The internal electrodes 20 may be formed on the magnetic material sheets. Additionally, the magnetic main body 10 may be formed by laminating the magnetic material sheets having the internal electrodes 20 formed thereon, and the external electrodes 30 may be electrically connected to the internal electrodes 20 and formed on a surface of the magnetic main body 10.

The content of each of the CoO and TiO₂ may be in the range of 0.05 to 1.0 parts by mole. This is because a secondary phase may not be formed by limiting the CoO and TiO₂, used to substitute Fe₂O₃, to a very small amount of less than 1.0 part by mole.

The content of the AgNO₃ may be in the range of 0.01 to 0.5 parts by weight with respect to 100 parts by weight of the Ni—Zn—Cu ferrite powder. When the content of AgNO₃ exceeds 0.5 parts by weight, a secondary phase may be generated, thereby deteriorating the magnetic properties of a sintered material.

The magnetic material composition may be used to manufacture a chip inductor, a chip bead, a ferrite core, and the like, and may also be used as a material of an inductor with a shape of a toroidal core.

Hereinafter, a method of manufacturing a ceramic electronic component will be described in detail.

First, a slurry including a Ni—Zn—Cu ferrite powder formed with 47.0 to 49.5 parts by mole of a mixture of Fe₂O₃, CoO, and TiO₂, 16.0 to 24.0 parts by mole of NiO, 18.0 to 25.0 parts by mole of ZnO, and 7.0 to 13.0 parts by mole of CuO, may be manufactured.

The slurry may be dried after a magnetic material sheet is manufactured using a doctor blade method or the like.

Paste may be coated on the magnetic material sheet using a silkscreen method or the like, so that a pattern of the internal electrode 20 may be formed. Here, the paste may be obtained by evenly distributing conductive metal powder such as Cu or Ag in an organic solvent.

Magnetic material sheets on which the internal electrodes 20 are printed may be laminated, to form a magnetic material laminate. A hole may be formed by punching the laminate, and the hole may be filled with conductive materials. The internal electrodes 20 may be electrically connected via the hole.

The laminate may be compressed, cut, and sintered, so that a ceramic electronic component, such as a chip inductor, may be manufactured.

The ceramic electronic component may have an excellent Q-factor, and may be manufactured in the same method as described above using a magnetic material composition for ceramic electronic components that includes a Ni—Zn—Cu ferrite powder formed with 47.0 to 49.5 parts by mole of a mixture of Fe₂O₃, CoO, and TiO₂, 0.05 to 1.0 part by mole of CoO, 0.05 to 1.0 part by mole of TiO₂, 16.0 to 24.0 parts by mole of NiO, 18.0 to 25.0 parts by mole of ZnO, and 7.0 to 13.0 parts by mole of CuO.

Here, the Q-factor refers to a ratio of storage energy to loss energy. A small amount of energy may be lost as the Q-factor increases. Accordingly, magnetic properties may be evaluated to be excellent. For example, when a power inductor used in a mobile phone has a large Q-factor, the standby power of the mobile phone may be consumed in a smaller amount.

Hereinafter, the present invention will be described in detail with reference to Inventive Examples and Comparative Examples. However, the scope of the present invention is not limited by the examples.

### INVENTIVE EXAMPLES

First, Fe₂O₃, NiO, ZnO, CuO, CoO, and TiO₂ were prepared as raw materials of a ferrite, and were weighed. Liquid milling was performed on the materials, and the milled materials were dried in a drying oven. The dried milled material was pulverized, and the pulverized powder was calcined at 750° C.

Subsequently, a magnetic material composition powder for ceramic electronic components was manufactured by pulverizing the calcined powder through milling. The manufactured magnetic material composition powder included 49.0 parts by mole of Fe₂O₃, 18 parts by mole of NiO, 22.0 parts by mole of ZnO, 11.0 parts by mole of CuO, and CoO, TiO₂.

Table 1 shows contents of the magnetic material composition for each of the inventive examples. To identify a change in properties based on the contents of CoO and TiO₂, the contents of CoO and TiO₂ were increased by 0.1 part by mole. Here, the content of CoO was equal to the content of TiO₂.

TABLE 1

Composition ratio (parts by mole)

| | Fe₂0₃ | NiO | ZnO | CuO | CoO | TiO₂ |
|---|---|---|---|---|---|---|
| Inventive | 48.8 | 18 | 22 | 11 | 0.1 | 0.1 |
| example 1 | | | | | | |
| Inventive | 48.6 | 18 | 22 | 11 | 0.2 | 0.2 |
| example 2 | | | | | | |
| Inventive | 48.4 | 18 | 22 | 11 | 0.3 | 0.3 |
| example 3 | | | | | | |
| Inventive | 48.2 | 18 | 22 | 11 | 0.4 | 0.4 |
| example 4 | | | | | | |
| Inventive | 48.0 | 18 | 22 | 11 | 0.5 | 0.5 |
| example 5 | | | | | | |
| Inventive | 47.8 | 18 | 22 | 11 | 0.6 | 0.6 |
| example 6 | | | | | | |
| Inventive | 47.6 | 18 | 22 | 11 | 0.7 | 0.7 |
| example 7 | | | | | | |
| Inventive | 47.4 | 18 | 22 | 11 | 0.8 | 0.8 |
| example 8 | | | | | | |

Referring to FIG. 1, the sum of contents of Fe₂O₃, CoO and TiO₂ was maintained to be 49.0 parts by mole, by equally increasing the content of CoO and the content of TiO₂ by 0.1 parts by mole, and by reducing the content of Fe₂O₃ by 0.2 parts by mole. In other words, a portion of Fe₂O₃ was substituted with CoO and TiO₂.

Polyvinyl alcohol (PVA) was added as a binder to the magnetic material composition powder, and a toroidal core with a diameter of 20 mm and an inner diameter of 13 mm was molded by applying a pressure of 2 ton/m² to the magnetic material composition powder to which the PVA was added. The molded toroidal core was sintered at 880° C., 900° C., and 920° C.

In each of inventive examples 1 to 8, shrinkage was measured by measuring a size of the toroidal core before and after the sintering operation. Additionally, a density of the toroidal core was measured after the sintering operation, to verify sintering properties of the magnetic material composition powder.

Furthermore, an initial permeability (uᵢ), a Q-factor (Q), a saturation magnetization (Ms), and a coercive force (Hc) were measured, to verify magnetic properties.

The initial permeability (uᵢ) and the Q-factor (Q) were measured at 1 Mhz by winding a wire over the toroidal core ten times. The saturation magnetization (Ms) was measured by applying an external magnetic field of 0.5 T to the toroidal core.

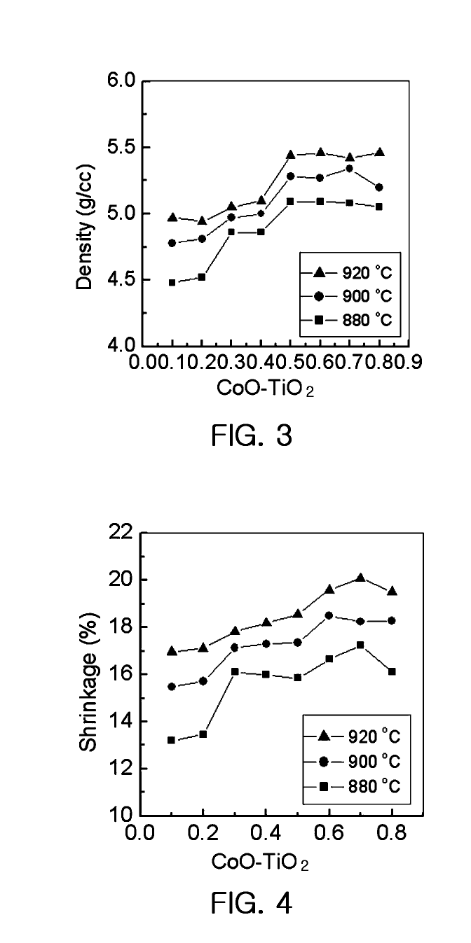

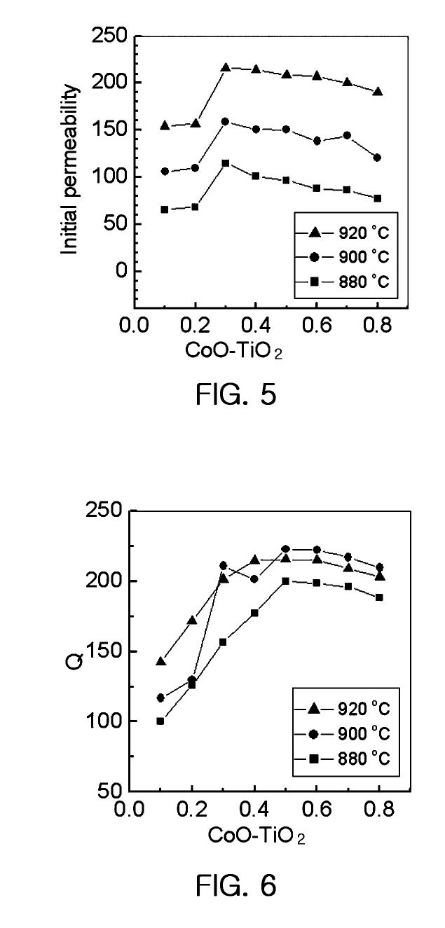

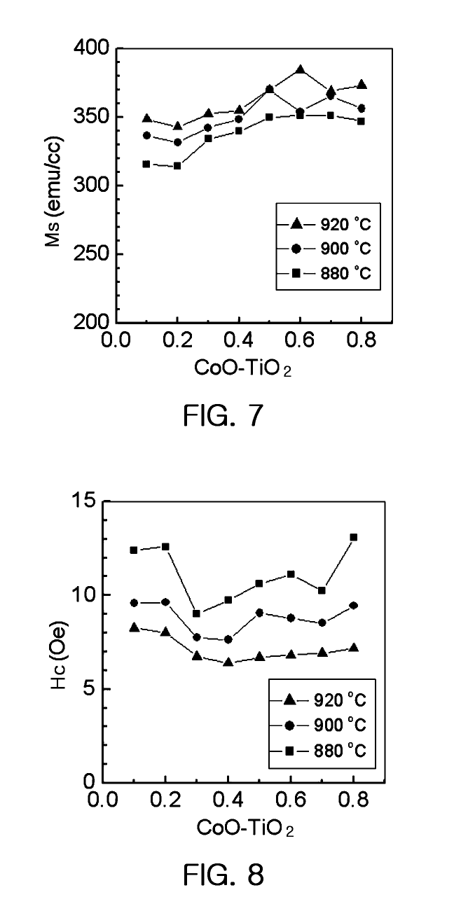

Results obtained by measuring the density, the shrinkage, the initial permeability (uᵢ), the Q-factor (Q), the saturation magnetization (Ms), and the coercive force (Hc) in inventive examples 1 to 8 are shown in Tables 2 to 4 and FIGS. 3 to 8.

TABLE 2

| Sintering | | Shrink- | Initial | | | |
|---|---|---|---|---|---|---|
| temperature: | Density | age | permeability | | Ms | Hc |
| 880° C. | (g/cc) | (%) | (uᵢ) | Q | (emu/cc) | (Oe) |
| Inventive | 4.48 | 13.19 | 65.5 | 100.2 | 315.6 | 12.38 |
| example 1 | | | | | | |
| Inventive | 4.52 | 13.44 | 68.2 | 125.9 | 314.1 | 12.59 |
| example 2 | | | | | | |
| Inventive | 4.86 | 16.11 | 114.8 | 156.7 | 334.0 | 9.01 |
| example 3 | | | | | | |
| Inventive | 4.86 | 15.98 | 100.7 | 177.5 | 339.7 | 9.73 |
| example 4 | | | | | | |
| Inventive | 5.09 | 15.84 | 96.7 | 200.0 | 349.7 | 10.61 |
| example 5 | | | | | | |
| Inventive | 5.09 | 16.65 | 87.9 | 198.5 | 351.3 | 11.12 |
| example 6 | | | | | | |
| Inventive | 5.08 | 17.24 | 86.5 | 196.0 | 351.3 | 10.26 |
| example 7 | | | | | | |
| Inventive | 5.05 | 16.11 | 76.9 | 188.0 | 347.0 | 13.07 |
| example 8 | | | | | | |

Table 2 shows a measurement result for inventive examples 1 to 8 when sintering was performed at 880° C.

Referring to Table 2 and FIGS. 3 to 8, as the contents of CoO and TiO₂ increase, the density and the shrinkage tend to increase. Accordingly, it can be seen that the sintering properties become better, as the contents of CoO and TiO₂ increase.

Additionally, it can be seen that the magnetic properties such as the initial permeability (uᵢ), the Q-factor (Q), the saturation magnetization (Ms), and the coercive force (Hc) were increased and then decreased again, as the contents of CoO and TiO₂ increase.

TABLE 3

| Sintering | | Shrink- | Initial | | | |
|---|---|---|---|---|---|---|
| temperature: | Density | age | permeability | | Ms | Hc |
| 900° C. | (g/cc) | (%) | (uᵢ) | Q | (emu/cc) | (Oe) |
| Inventive | 4.78 | 15.47 | 105.6 | 116.6 | 336.2 | 9.57 |
| example 1 | | | | | | |
| Inventive | 4.81 | 15.71 | 109.9 | 129.8 | 331.6 | 9.62 |
| example 2 | | | | | | |
| Inventive | 4.97 | 17.13 | 158.6 | 210.7 | 342.2 | 7.74 |
| example 3 | | | | | | |
| Inventive | 5.00 | 17.30 | 150.9 | 201.4 | 348.5 | 7.63 |
| example 4 | | | | | | |
| Inventive | 5.28 | 17.34 | 150.5 | 222.5 | 369.9 | 9.06 |
| example 5 | | | | | | |
| Inventive | 5.27 | 18.48 | 138.4 | 222.0 | 353.9 | 8.78 |
| example 6 | | | | | | |
| Inventive | 5.34 | 18.24 | 143.8 | 217.0 | 365.5 | 8.52 |
| example 7 | | | | | | |
| Inventive | 5.20 | 18.27 | 120.7 | 209.5 | 356.0 | 9.43 |
| example 8 | | | | | | |

Table 3 shows a measurement result for inventive examples 1 to 8 when sintering was performed at 900° C.

Referring to Table 3 and FIGS. 3 to 8, as the contents of CoO and TiO₂ increase, the density and the shrinkage tend to increase. Accordingly, it can be seen that the sintering properties become better, as the contents of CoO and TiO₂ increase.

Additionally, it can be seen that the magnetic properties such as the initial permeability (uᵢ), the Q-factor (Q), the saturation magnetization (Ms), and the coercive force (Hc) also tend to increase, as the contents of CoO and TiO₂ increase.

TABLE 4

| Sintering | | Shrink- | Initial | | | |
|---|---|---|---|---|---|---|
| temperature: | Density | age | permeability | | Ms | Hc |
| 920° C. | (g/cc) | (%) | (uᵢ) | Q | (emu/cc) | (Oe) |
| Inventive | 4.97 | 16.96 | 154.36 | 142.2 | 348.7 | 8.26 |
| example 1 | | | | | | |
| Inventive | 4.94 | 17.10 | 156.7 | 171.8 | 342.7 | 8.02 |
| example 2 | | | | | | |
| Inventive | 5.05 | 17.82 | 215.6 | 201.3 | 352.2 | 6.74 |
| example 3 | | | | | | |
| Inventive | 5.10 | 18.17 | 214.3 | 214.8 | 354.7 | 6.41 |
| example 4 | | | | | | |
| Inventive | 5.44 | 18.55 | 208.6 | 215.5 | 370.0 | 6.69 |
| example 5 | | | | | | |
| Inventive | 5.46 | 19.58 | 207.1 | 215.0 | 384.4 | 6.82 |
| example 6 | | | | | | |
| Inventive | 5.42 | 20.08 | 200.0 | 209.0 | 368.9 | 6.92 |
| example 7 | | | | | | |
| Inventive | 5.46 | 19.51 | 190.6 | 203.0 | 373.2 | 7.17 |
| example 8 | | | | | | |

Table 4 shows a measurement result for inventive examples 1 to 8 when sintering was performed at 920° C.

Referring to Table 4 and FIGS. 3 to 8, as the contents of CoO and TiO₂ increase, the density and the shrinkage tend to increase. Accordingly, it can be seen that the sintering properties become better, as the contents of CoO and TiO₂ increase.

Additionally, it can be seen that the magnetic properties such as the initial permeability (uᵢ), the Q-factor (Q), the saturation magnetization (Ms), and the coercive force (Hc) were increased and then decreased again, as the contents of CoO and TiO₂ increase.

### Comparative Examples

In Comparative Examples 1 to 4, Fe₂O₃ was substituted with only TiO₂.

Composition ratios for comparative examples 1 to 4 are shown in Table 5 below. The content of TiO₂ was increased and the content of Fe₂O₃ was reduced, while maintaining the sum of the contents of Fe₂O₃ and TiO₂ to be 49.0 parts by mole.

TABLE 5

| | Composition ratio (parts by mole) | | | | |
|---|---|---|---|---|---|
| | Fe₂0₃ | NiO | ZnO | CuO | TiO₂ |
| Compataive | 48.8 | 18 | 22 | 11 | 0.2 |
| example 1 | | | | | |
| Comparative | 48.6 | 18 | 22 | 11 | 0.4 |
| example 2 | | | | | |
| Comparative | 48.4 | 18 | 22 | 11 | 0.6 |
| example 3 | | | | | |
| Comparative | 48.2 | 18 | 22 | 11 | 0.8 |
| example 4 | | | | | |

In comparative examples 1 to 4, toroidal cores were manufactured by the same manufacturing process as in inventive examples 1 to 8, and the sintering properties and magnetic properties of the toroidal cores were measured in the same manner as in inventive examples 1 to 8.

Tables 6 to 8 show results obtained by measuring the density, the shrinkage, the initial permeability (uᵢ), the Q-factor (Q), the saturation magnetization (Ms), and the coercive force (Hc) in comparative examples 1 to 4 when sintering was performed at 880° C., 900° C., and 920° C.

TABLE 6

| Sintering | | Shrink- | Initial | | | |
|---|---|---|---|---|---|---|
| temperature: | Density | age | permeability | | Ms | Hc |
| 880° C. | (g/cc) | (%) | (uᵢ) | Q | (emu/cc) | (Oe) |
| Comparative | 4.7 | 15.7 | 87.8 | 105.0 | 322.8 | 11.3 |
| example 1 | | | | | | |
| Comparative | 4.5 | 14.0 | 60.2 | 88.5 | 311.4 | 14.6 |
| example 2 | | | | | | |
| Comparative | 4.2 | 11.8 | 37.1 | 74.0 | 293.0 | 18.1 |
| example 3 | | | | | | |
| Comparative | 4.1 | 11.0 | 32.5 | 69.0 | 279.1 | 19.7 |
| example 4 | | | | | | |

TABLE 7

| Sintering | | Shrink- | Initial | | | |
|---|---|---|---|---|---|---|
| temperature: | Density | age | permeability | | Ms | Hc |
| 900° C. | (g/cc) | (%) | (uᵢ) | Q | (emu/cc) | (Oe) |
| Comparative | 4.8 | 16.9 | 126.6 | 117.5 | 343.0 | 9.0 |
| example 1 | | | | | | |
| Comparative | 4.7 | 15.5 | 90.2 | 102.5 | 334.5 | 11.1 |
| example 2 | | | | | | |
| Comparative | 4.4 | 13.6 | 54.1 | 85.5 | 310.0 | 14.8 |
| example 3 | | | | | | |
| Comparative | 4.3 | 12.8 | 45.6 | 80.0 | 298.9 | 16.3 |
| example 4 | | | | | | |

TABLE 8

| Sintering | | Shrink- | Initial | | | |
|---|---|---|---|---|---|---|
| temperature: | Density | age | permeability | | Ms | Hc |
| 920° C. | (g/cc) | (%) | (uᵢ) | Q | (emu/cc) | (Oe) |
| Comparative | 5.0 | 18.2 | 187.7 | 124.0 | 358.5 | 7.5 |
| example 1 | | | | | | |
| Comparative | 4.9 | 17.4 | 137.2 | 114.5 | 344.9 | 9.3 |
| example 2 | | | | | | |
| Comparative | 4.7 | 16.1 | 130.3 | 99.5 | 325.6 | 11.2 |
| example 3 | | | | | | |
| Comparative | 4.6 | 15.3 | 70.1 | 94.0 | 325.1 | 12.2 |
| example 4 | | | | | | |

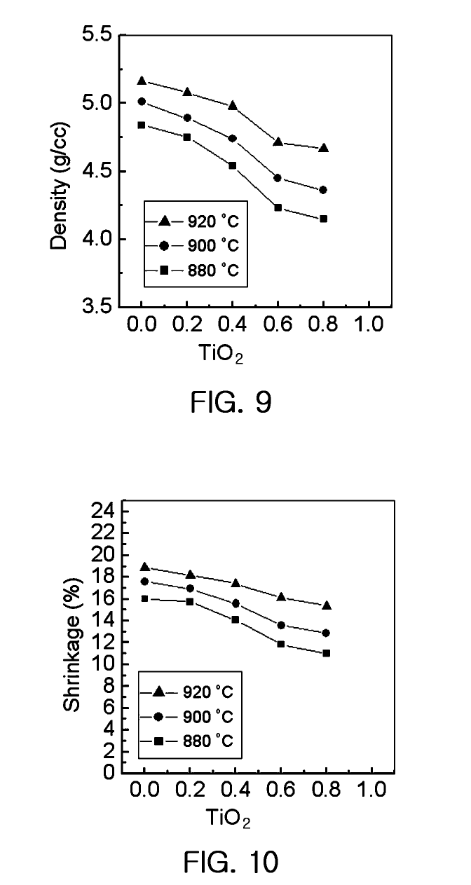

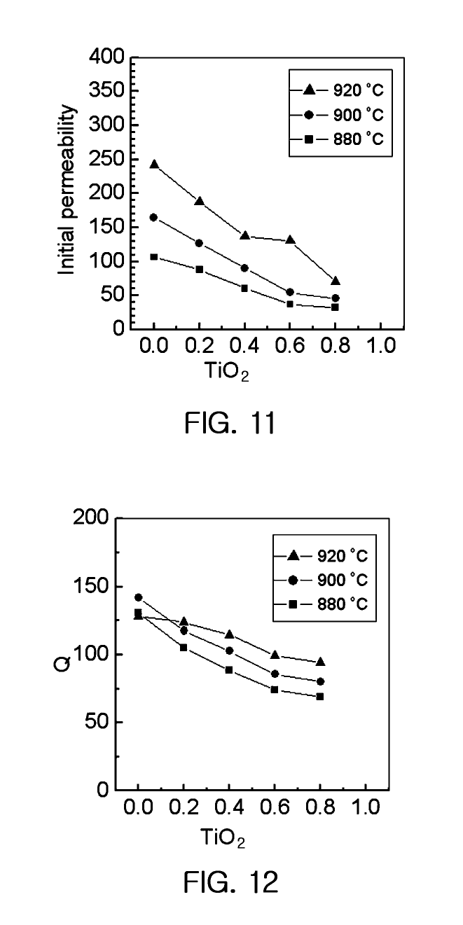

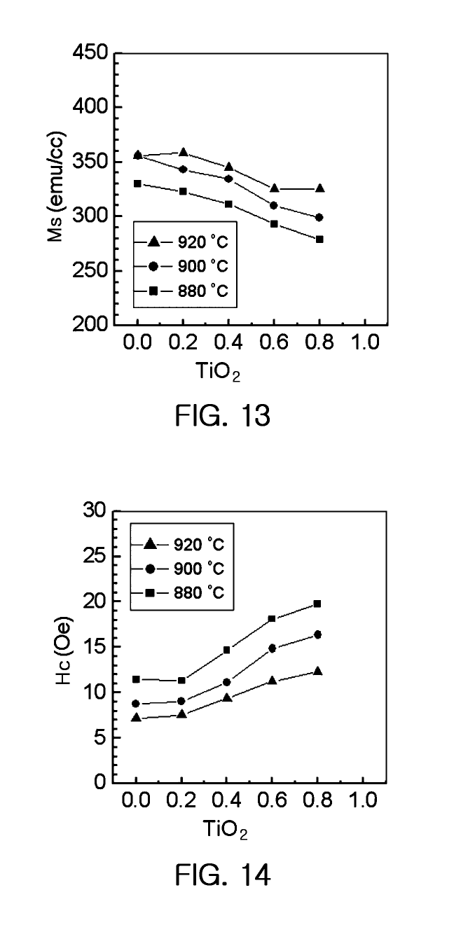

Referring to Tables 6 to 8 and FIGS. 9 to 14, the sintering properties and magnetic properties were reduced as the content of TiO₂ increased, when the sintering was performed at 880° C., 900° C., and 920° C.

Accordingly, it can be seen that the substituting of Fe₂O₃ with TiO₂ may have a bad influence on the improvement of the sintering properties and magnetic properties, rather than having no influence thereupon.

Comparative examples 1 to 4 show an opposite tendency to inventive examples 1 to 8 in which the sintering properties and magnetic properties are improved as the contents of CoO and TiO₂ increase.

As set forth above, according to exemplary embodiments of the invention, a ceramic electronic component having a low sintering temperature and excellent Q-factor can be provided.

While the present invention has been shown and described in connection with the exemplary embodiments, it will be apparent to those skilled in the art that modification and variation can be made withough departing from the spirit and scope of the invention as defined by the appended claims.

What is claimed is:

1. A magnetic material composition for ceramic electronic components, the magnetic material composition comprising Ni—Zn—Cu ferrite powder formed of 47.0 to 49.5 parts by mole of a mixture of iron oxide (Fe₂O₃), cobalt oxide (CoO), and titanium oxide (TiO₂), 16.0 to 24.0 parts by mole of nickel oxide (NiO), 18.0 to 25.0 parts by mole of zinc oxide (ZnO), and 7.0 to 13.0 parts by mole of copper oxide (CuO).

2. The magnetic material composition of claim 1, wherein a content of CoO is equal to a content of TiO₂.

3. The magnetic material composition of claim 1, wherein a content of each of CoO and TiO₂ is in the range of 0.05 to 1.0 part by mole.

4. The magnetic material composition of claim 1, further comprising silver nitrate (AgNO₃).

5. The magnetic material composition of claim 4, wherein a content of AgNO₃ is in the range of 0.01 to 0.5 parts by weight with respect to 100 parts by weight of the Ni—Zn—Cu ferrite powder.

6. A method of manufacturing a magnetic material composition for ceramic electronic components, the method comprising:
preparing raw materials comprising iron oxide (Fe₂O₃), nickel oxide (NiO), zinc oxide (ZnO), copper oxide (CuO), cobalt oxide (CoO), and titanium oxide (TiO₂);
mixing the raw materials and performing liquid milling on a mixture of the raw materials; and
manufacturing Ni—Zn—Cu ferrite powder by drying the milled mixture and calcining the dried mixture.

7. The method of claim 6, further comprising, after the manufacturing of the Ni—Zn—Cu ferrite powder, mixing silver nitrate (AgNO₃) in the manufactured Ni—Zn—Cu ferrite powder.

8. The method of claim 7, wherein a content of AgNO₃ is in the range of 0.01 to 0.5 parts by weight with respect to 100 parts by weight of the Ni—Zn—Cu ferrite powder.

9. The method of claim 6, wherein the Ni—Zn—Cu ferrite powder is formed of 47.0 to 49.5 parts by mole of a mixture of Fe₂O₃, CoO, and TiO₂, 16.0 to 24.0 parts by mole of NiO, 18.0 to 25.0 parts by mole of ZnO, and 7.0 to 13.0 parts by mole of CuO.

10. The method of claim 7, wherein a content of each of CoO and TiO₂ is in the range of 0.05 to 1.0 part by mole.

11. The method of claim 6, wherein the calcining of the mixture is performed at 700° C. to 800° C.

12. A ceramic electronic component, comprising:
a magnetic material sheet manufactured using a magnetic material composition comprising Ni—Zn—Cu ferrite powder formed of 47.0 to 49.5 parts by mole of a mixture of iron oxide (Fe₂O₃), cobalt oxide (CoO), and titanium oxide (TiO₂), 16.0 to 24.0 parts by mole of nickel oxide (NiO), 18.0 to 25.0 parts by mole of zinc oxide (ZnO), and 7.0 to 13.0 parts by mole of copper oxide (CuO); and
an internal electrode formed on the magnetic material sheet.

13. The ceramic electronic component of claim 12, wherein a content of each of CoO and TiO₂ is in the range of 0.05 to 1.0 part by mole.

14. The ceramic electronic component of claim 12, wherein the magnetic material composition further comprises silver nitrate (AgNO₃).

15. The ceramic electronic component of claim 14, wherein a content of AgNO₃ is in the range of 0.01 to 0.5 parts by weight with respect to 100 parts by weight of the Ni—Zn—Cu ferrite powder.
